(19) United States
(12) Patent Application Publication
(10) Pub. No.: US 2026/0362157 A1
(43) Pub. Date: Nov. 12, 2026

(54) OPEN RADIO ACCESS NETWORK (O-RAN) COMPONENT TESTING AND VALIDATION PORTAL SYSTEM

(71) Applicant: DISH Wireless L.L.C., Englewood, CO (US)

(72) Inventors: Eric William Moore, Highlands Ranch, CO (US); Sanjay Chelluvaraya Swamy Gowda, Lakewood, CO (US); Sachin Singh, Aurora, CO (US)

(21) Appl. No.: 19/261,831

(22) Filed: Jul. 7, 2025

Related U.S. Application Data
(60) Provisional application No. 63/804,398, filed on May 12, 2025.

(51) Int. Cl. H04W 16/22; H04W 24/10

(52) U.S. Cl. CPC H04W 16/22; H04W 24/10

(57) ABSTRACT

A computing system executing an open radio access network (O-RAN) testing and validation portal architecture. The computing system includes one or more processing devices to display, in a user interface, a component type dropdown menu within an add new project page. The devices receive, through the user interface, selection of an O-RAN component type. The devices receive information, through text upload fields of the user interface, identifying a project for testing and validating an O-RAN component corresponding to the O-RAN component type. The devices receive testing parameter(s) through a set of selection pulldown menus displayed on the add new project page. The devices create the project, a status for which is trackable via integrated communication with an O-RAN lab, in response to detecting submission of the add new project page and using the O-RAN component type, the information, and the one or more testing parameters.

### CLAIM OF PRIORITY

The present application claims the benefit under 35 U.S.C. § 119(e) of U.S. Provisional Patent Application No. 63/804,398, filed May 12, 2025, which is incorporated by reference herein.

### FEDERALLY SPONSORED RESEARCH OR DEVELOPMENT

This invention was made with government support under 08-60-IF014 awarded by the National Institute of Standards and Technology. The government has certain rights in the invention.

### BACKGROUND

Some telecommunication networks, such as cellular networks, are built on Open Radio access Network (O-RAN or ORAN) technology, which is a modern approach to building mobile networks related to the RAN portion of the network. The RAN portion of a mobile or cellular network connects user or station devices (e.g., phones, computers, data units, internet of things (IoT) devices, and the like) to a core network such as a fifth generation (5G) core network. The main goals of O-RAN are interoperability, flexibility, innovation, and cost efficiency by opening up the traditionally closed and proprietary RAN architectures.

O-RAN defines standardized, open interfaces (e.g., Open Fronthaul Interface) between RAN components, allowing operators to mix and match hardware and software from different vendors. Unlike traditional RAN systems where a single vendor provides tightly integrated hardware and software, O-RAN enables virtualized and disaggregated components. O-RAN specifications are developed by the O-RAN Alliance, an industry consortium, with many standards published openly to the public.

Design and operation of various network components are governed by O-RAN-related protocols and specifications, which will be discussed. These components include, for example, the radio unit (RU), which handles radio frequency (RF) functions like transmission and reception, the distributed unit (DU), which manages real-time first and second layer (L1/L2) functions (e.g., medium access control (MAC) and radio link control (RLC)), the central unit (CU), which manages higher layer functions (e.g., packet data convergence protocol (PDCP) and radio resource control (RRC)), and the RAN intelligent controller (RIC). As to the latter, a near-real-time RIC handles optimization and control with sub-second latency while a non-real-time RIC manages policy, artificial intelligence (AI) or machine learning (ML) training, and long-term analytics.

The O-RAN protocols and specifications further include service management and orchestration (SMO), which oversees configuration, fault handling, and lifecycle management. O-RAN supports 4G LTE and 5G New Radio (NR) protocols. O-RAN, however, does not define new air interfaces; rather, O-RAN enables these protocols to run over an open and modular architecture. In 5G, especially with virtualized RAN (vRAN) and cloud-native cores, O-RAN's value is amplified due to the need for dynamic, scalable, and programmable infrastructure. Key third generation partnership project (3GPP) protocols (e.g., RRC, MAC, PHY, etc.) still govern radio operation, but O-RAN redefines how and by whom those protocols are implemented and managed. Some advantages of using O-RAN technology in a mobile or cellular network includes greater vendor diversity and reduced costs, rapid innovation and AI-driven optimization via RIC, and easier upgrades and customization.

### BRIEF DESCRIPTION OF DRAWINGS

The present disclosure is illustrated by way of example, and not by way of limitation, in the figures of the accompanying drawings.

FIG. 1A is a block diagram of a cellular network system including a computing system in or associated with the cellular network for purposes of testing and validation of O-RAN components within a cellular network according to at least one embodiment.

FIG. 1B is a block diagram of the computing system of FIG. 1A according to some embodiments.

FIG. 2 is a block diagram of an example computing system illustrating an O-RAN testing and validation portal architecture according to some embodiments.

FIG. 3 is a user interface (UI) of the O-RAN portal illustrating a project summary and details dashboard page according to some embodiments.

FIG. 4A is a user interface of the O-RAN portal illustrating an add new CU project page in a UI window according to some embodiments.

FIG. 4B is a user interface of the O-RAN portal illustrating an add new DU project page in a UI window according to some embodiments.

FIG. 4C and FIG. 4D are a user interface of the O-RAN portal illustrating an add new CU-DU project page in a UI window according to some embodiments.

FIG. 4E and FIG. 4F are a user interface of the O-RAN portal illustrating an add new RU project page in a UI window according to some embodiments.

FIG. 5 is a user interface of the O-RAN portal illustrating a project details page in a UI window that includes phase-based testing progress according to some embodiments.

FIG. 6 is a user interface of the O-RAN portal illustrating a profile page in a UI window according to some embodiments.

FIG. 7 is a user interface of the O-RAN portal illustrating a manage organization page in a UI window according to some embodiments.

FIG. 8 is a user interface of the O-RAN portal illustrating a manage users page in a UI window according to some embodiments.

FIG. 9 is a flow chart of an example method 900 for creating a new project for performing O-RAN component testing and validation according to some embodiments.

FIG. 10 illustrates a block diagram illustrating an exemplary computer device (or computing device), in accordance with implementations of the present disclosure.

### DETAILED DESCRIPTION

Current methods in some mobile or cellular networks to test and validate O-RAN components is to manually test processes without any sort of integrated platform for managing test submissions. Further, there is no automated reporting, no standardized workflow for O-RAN validation, and other labs merely employ simulation-based testing (or running software to represent the component and see how the simulated component is expected to function in a simulated network environment). There is also no existing unified portal for organization management and test tracking. As a consequence of these deficiencies, current organizations and methods are clunky, disorganized, and slow in deployment. Further, the actual testing is not tied to real-world network conditions and thus testing and validation are inaccurate.

Aspects and embodiments of the present disclosure overcome the above-mentioned deficiencies and others by implementing an automated, end-to-end testing process that exposes O-RAN components to real commercial stack testing (not just simulation) associated with an O-RAN testing and validation portal architecture. Further, O-RAN testing and validation portal architecture, which includes access via an extensive user interface, is described that integrates organization management and validation and provides automated report generation. Further, the portal architecture enables a structured phase-based testing approach after a new project is created through use of a user interface of the portal architecture.

In various embodiments, progress through such testing phases is trackable across multiple testing phases for different components, organizations, and managers. For example, in some embodiments, a first phase includes onboarding and intake, a second phase includes conformance interoperability security testing, a third phase includes capacity and performance testing, and a fourth (or final) phase includes commercial readiness testing. In at least one embodiment, movement between phases within the portal architecture is sequential such that an earlier phase is completed before a subsequent phase can begin. In some embodiments, the testing and validation are performed by a testing laboratory (or lab) with actual vendor O-RAN components. In other embodiments, the testing and validation is performed in the field (e.g., in a mobile lab) with actual vendor O-RAN components currently in network operation.

The portal architecture can further provide an interactive communication platform between vendors and the testing lab. In embodiments, such interactive communication platform includes automated initiation of testing and movement between phases of testing based on testing progress. Such automated initiation and progress can be updated through the interactive communication platform in a way that also automates report generation through the user interface of the portal architecture. Although the present embodiments are particularly directed to 5G networks, later generation cellular networks (e.g., 6G, 7G, etc.) are also envisioned.

In various embodiments, a computing system is disclosed that executes an O-RAN testing and validation portal architecture. The computing system can include one or more processing devices to display, in a user interface, a component type dropdown menu within an add new project page. The processing device(s) can receive, through the user interface, selection of a first O-RAN component type. The processing device(s) can receive information, through text upload fields of the user interface, identifying a project for testing and validating a first O-RAN component corresponding to the first O-RAN component type. The processing device(s) can receive testing parameter(s) through a set of selection pulldown menus displayed on the add new project page. The processing device(s) can create the project, a status for which is trackable by the computing system, in response to detecting submission of the add new project page and using the first O-RAN component type, the information, and the one or more testing parameters.

Particular implementations of the subject matter described in this disclosure can be implemented so as to realize one or more of the following advantages. For example, the disclosed O-RAN testing and validation portal architecture streamlines the O-RAN component testing process, enables commercial validation of O-RAN components in real network environments, integrates communication operation with an O-RAN lab that is performing the testing, manages relationships with vendors, and provides a structured testing approach. These and other solutions and advantages will be discussed in more detail.

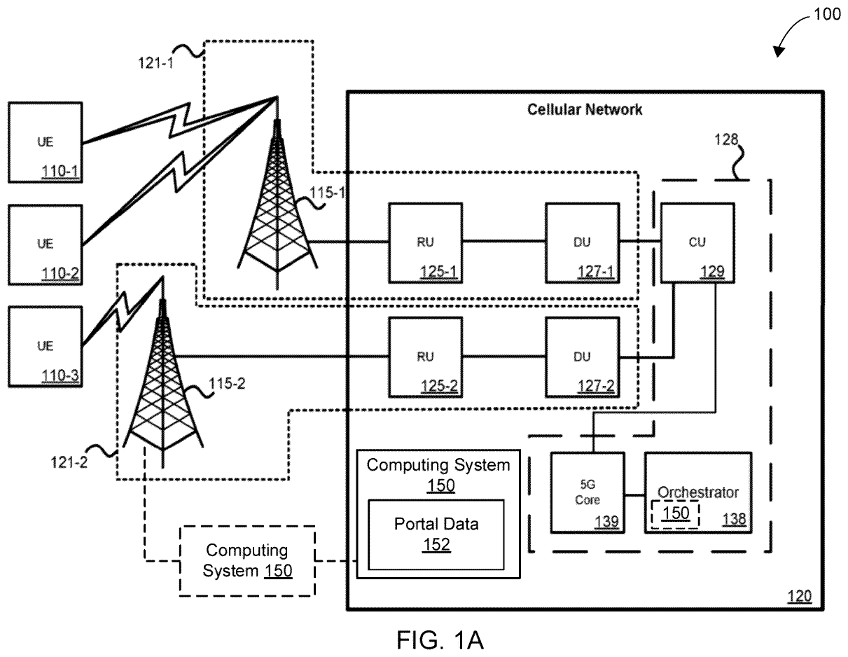

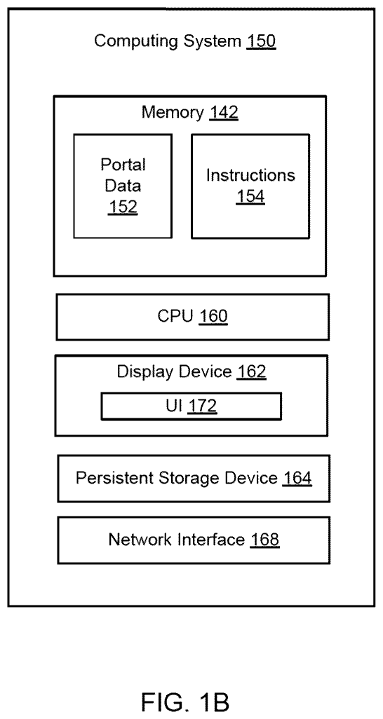

FIG. 1A is a block diagram of a cellular network system 100 including a computing system 150 in or associated with the cellular network for purposes of testing and validation of O-RAN components according to at least one embodiment. FIG. 1A represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station structure 115; cellular network 120; radio units 125 (“RUs 125”); distributed units 127 (“DUs 127”); central unit 129 (“CU 129”); 5G core 139, and orchestrator 138. FIG. 1A represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), and other computerized devices capable of communicating via a cellular network, etc. Generally, UE 110 can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. Although more are envisioned, two base stations 121-1 and 121-2 are illustrated. In embodiments, base station 121-1 can include structure 115-1, RU 125-1, and DU 127-1, where structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations and many CUs and 5G core 139. Each structure 115 can include one or more antennas that allow RUs 125 to communicate wirelessly with UEs 110. RUs 125 can each represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1 and DU 127-2, may communicate with CU 129. Collectively, an RU, DU, and CU create a gNodeB, which serves as the radio access network (RAN) of cellular network 120. CU 129 can communicate with the 5G core 139. The specific architecture of the cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1A illustrates various components of cellular network 120, other embodiments of cellular network 120 can vary the arrangement, communication paths, and specific components of cellular network 120, which will be expanded on in subsequent Figures. While each RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so it may be desired to avoid allocation of an excess of resources to a particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing can be performed.

The 5G core 139, which can be physically distributed across data centers or located at a central national data center (NDC), can perform various core functions of the cellular network. The 5G core 139 can include: network resource management components; policy management components; subscriber management components; and packet control components, among others. Individual components may communicate on a bus, thus allowing various components of 5G core 139 to communicate with each other directly. The 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

The 5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

As illustrated in FIG. 1A, the system 100 includes a computing system 150 or data platform. The computing system 150 can be distrusted in some embodiments and include a suite of tools and technologies designed to manage, store, process, analyze, and/or visualize large volumes of data, including execution of software applications that carry out aspects of the cellular network (e.g., in the cloud). In varying embodiments, the computing system 150 is located in or implemented as part of the orchestrator 138, is located within the cellular network 120 but outside of the main cellular network components 128, or is located outside of the cellular network 120 but is capable of monitoring data such as capacity and connectivity information by connecting to the cellular network 120 in similar ways that does a server or other networked computing system.

In at least one embodiment, the computing system 150 is a distributed set of processing devices located in one or more of these three locations that can share one or more memory or storage devices that are capable of storing portal data 152 (see FIG. 1B). In embodiments, the portal data 152 is associated with execution of software applications and other functionality carried out for the O-RAN testing and validation portal architecture, as will be described in more detail. The computing system 150 can aggregate and track such portal data 152 for purposes of performing O-RAN testing and validation of O-RAN components from different vendors.

In some embodiments, the computing system 150 is used by modern data-driven organizations, enabling them to harness the power of their data for various purposes, such as business intelligence, analytics, machine learning, and more. In general, the computing system 150 includes components for data ingestion, data storage, data processing, data management, data integration, data analytics, machine learning (ML) and artificial intelligence (AI) platforms, data security, or the like. For example, a data ingestion component can use extract, transform, load (ETL) logic (tools or processes) that extract data from various sources, transform it into a suitable format, and load it into a storage system. The data ingestion component can be set up to stream real-time data from sources, such as Internet of Things (IoT) devices, transactional systems, or other network functions. The computing system 150 can include data storage components, such as data lakes, data warehouses, database systems. Data lakes are large storage repositories that hold raw data in its native format until it is needed. A data warehouse is a structured storage system optimized for query performance and analytics, often storing cleaned and processed data. Database Systems can include both relational (e.g., SQL) and non-relational (e.g., NoSQL) databases for various data storage needs. The data processing components can handle batch processing, streaming processing, or the like. Batch processing can handle large volumes of data in batches, typically for tasks like reporting, data transformation, and aggregation. Stream processing can handle real-time processing of continuous data streams to support applications like real-time analytics and monitoring.

Data management components can handle metadata management and data governance. The metadata management can include tools for managing metadata, which is data about data, including data catalogs, lineage, and governance. Data Governance can include policies and processes to ensure data quality, security, privacy, and compliance with regulations.

Data integration components can provide application programming interfaces (APIs), data virtualization, etc. The APIs can be used for accessing and integrating data across different systems. Data Virtualization techniques can be used for abstracting and integrating data from various sources without moving it physically. The data analytics components can have business intelligence (BI) and advanced analytics tools and platforms for data reporting, visualization, and dashboards to support decision-making. Advanced analytics techniques, like data mining, predictive analytics, and statistical analysis, can be used to derive deeper insights. Such ML/AI platforms can provide a model training platform for developing and training machine learning models using data stored in the platform, and a model deployment platform for deploying trained models into production environments for real-time or batch inference. Data security components can provide access control, encryption, etc. Access control mechanisms can be used for ensuring that only authorized users can access specific data. Encryption techniques can be used for protecting data both at rest and in transit to prevent unauthorized access and breaches by unauthorized users.

The computing system 150 can consolidate data from various sources into a single platform, making it easier to manage and access. The computing system 150 can support large-scale data storage and processing, accommodating growing data volumes and increasing complexity. The computing system 150 can enable real-time data processing and analytics, allowing organizations to respond quickly to changing conditions. The computing system 150 can facilitate collaboration across different departments and teams by providing a unified data environment. The computing system 150 can implement data governance and quality control measures to ensure the accuracy and reliability of data. The computing system 150 can provide organizations with the tools and insights needed to make informed, data-driven decisions. In summary, the computing system 150 can provide the infrastructure and tools needed to manage, process, and analyze data effectively, enabling organizations to unlock the full potential of their data assets. The computing system 150 can also provide business intelligence and reporting. The computing system 150 can aggregate data from multiple sources to generate comprehensive reports and dashboards for business analysis. The computing system 150 can provide real-time analytics. In particular, the computing system 150 can monitor and analyze data streams in real-time to gain immediate insights and drive instant actions. The computing system 150 can provide customer insights by analyzing customer data to understand behavior patterns, preferences, and trends to improve customer experience and loyalty. The computing system 150 can implement predictive maintenance as well, such as using machine learning models to predict equipment failures, capacity deficiencies, and schedule proactive capacity solutions and/or maintenance.

FIG. 1B is a block diagram of the computing system 150 of FIG. 1A according to some embodiments. In at least some embodiments, the computing system 150 includes memory 142, a central processing unit (CPU) or other processor, a display device 162, a persistent storage device 164, and a network interface 168. The memory 142 (as well as the persistent storage device 164) can store portal data 152 and instructions 154. The CPU 160 can include one or more processing devices in the case that the computing system 150 is distributed, while the memory 142 and the persistent storage devices 164 (among other components) may or may not be distributed, e.g., located across different locations of a network such as the cellular network 120 or within the cloud with which the cellular network 120 communicates.

For example, in embodiments, the computing system 150 is implemented in a cloud computing system, providing data storage, data warehousing, real-time data processing, analytic engines for large-scale data processing, ML/AI services, data flow for stream and batch processing, or other data services. As described in more detail below, the computing system 150 can provide and present a UI 172 (or GUI) within the display device 162 in connection with executing jobs associated with cellular network applications. Management of job execution may be instantiated within the instructions 154, which when executed by the one or more processing devices of the CPU 160, presents the UI 172 with menu options that users can select, e.g., that are from proprietary and/or third-party sources. Once selected, for example, different testing component project information and data can be received through the UI 172 for performing O-RAN component testing and validation, as will be discussed in more detail hereinafter. In some embodiments, the UI 172 includes, in connection with the CPU 160, a framework capable of generating and/or modifying executable code (represented by graphical objects in a GUI) for utility programs, applications, functions, routines, scripts, processing pipelines, solutions, connector functions, object stores, enterprise integration tools, or other executable code associated with network software.

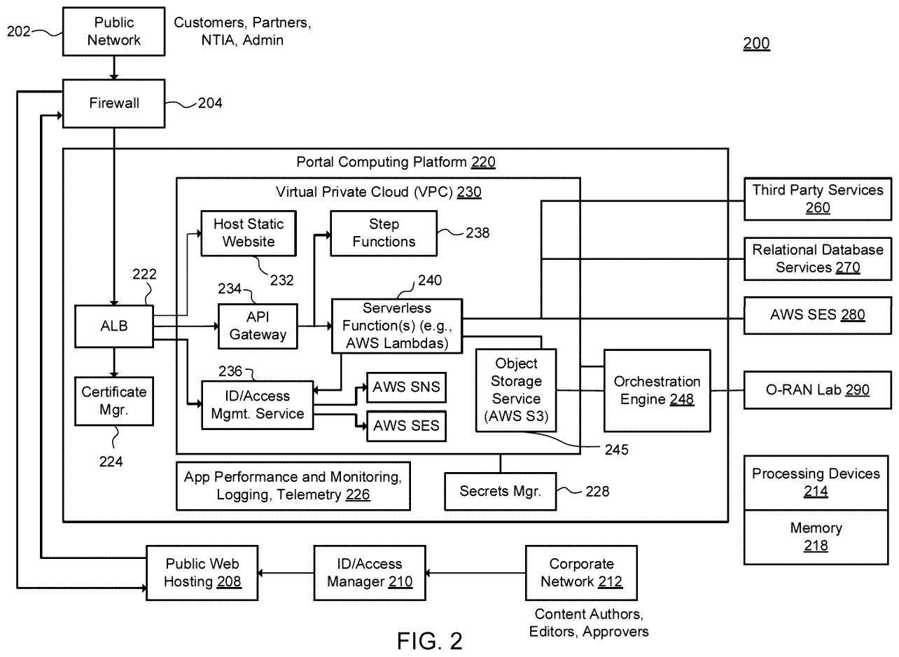

FIG. 2 is a block diagram of an example computing system 200 illustrating an O-RAN testing and validation portal architecture according to some embodiments. In some embodiments, the computing system 200 is or includes at least a portion of the computing system 150 discussed with reference to FIGS. 1A-1B. As with the computing system 150, the computing system 200 can be distributed and operate in the cloud. For example, the computing system 200 may be implemented using one or more processing devices 214 and memory 218 that is provided in cloud-based data centers. The memory 218 can represent both volatile memory (e.g., system memory) and non-volatile memory (e.g., long-term storage), as was discussed with reference to the memory 142 and persistent storage device 164 (FIG. 1B).

In various embodiments, the O-RAN testing and validation portal architecture includes a public network 202 (accessible by customers, partners, the National Telecommunications and Information Administration (NITA), and portal administrators), a firewall 204 to protect access to a portal computing platform 220 (such as Amazon Web Services or AWS®, Microsoft Azure®, Google Cloud Platform or GCP®, IBM® Cloud or the like), the portal computing platform 220, public web hosting 208 (such as SquareSpace®) that also communicates through the firewall 204, an identification and access manager 210 (such as Okta®), and a corporate network 212 (accessible to content authors, editors, and approvers, for example). The O-RAN testing and validation portal architecture can further include access to third party services 260 (such as PaloAlto Networks®, ServiceNow® workflow management system, or the like), relational database services 270 (such as Amazon RDS™, PostgreSQL, or the like), AWS® Simple Email Service (SES) 280, and a O-RAN laboratory or O-RAN lab 290.

In some embodiments, the portal computing platform 220 includes an orchestration engine 248 (which can employ ServiceNow®, for example) for the orchestration of the different phases of the O-RAN component testing, as will be discussed in more detail, including for orchestration or integration between the portal architecture and automation or operation of the O-RAN lab 290. In this way, ServiceNow® provides a loose coupling between the front end interface of the portal architecture and the back end operation of the O-RAN lab 290 that performs the testing associated with most of the test phases, as will be described. As was discussed, the O-RAN lab 290 can either be a static lab to which other vendor O-RAN components are located for testing or a field lab that is mobile and able to be tested in a field environment with O-RAN components currently in network operation. In either scenario, the testing and validation can be performed on an actual software stack, not on simulated hardware and/or software of O-RAN components.

In at least some embodiments, the portal computing platform 220 includes an application load balance or ALB 222, a certificate manager 224 (which can be provided by AWS®), application performance and monitoring, logging, and telemetry services 226 (such as AWS® CloudWatch, AWS® CloudTrail, Dynatrace, or the like), a secrets manager 228 (which can be provided by AWS®), a virtual private cloud or VPC 230, and the orchestration engine 248. The ALB 222 can be a Layer 7 (HTTP/HTTPS) load balancer in AWS® elastic load balancing (ELB) that intelligently routes incoming traffic to multiple backend targets (like Amazon® Elastic Compute Cloud (EC2) instances, containers, or Lambda functions) based on content of the request—such as uniform resource locator (URL) path, host headers, HTTP methods, or query parameters.

In some embodiments, the VPC 230 is a logically isolated, virtual network within the AWS® cloud where one can launch and manage AWS® resources (like EC2, RDS, Lambda, etc.) in a secure and controlled environment, similar to a traditional on-premises network. AWS® Lambda is a serverless compute service that enables a compute environment to run code without provisioning or managing servers. One can simply write function code, upload the code, and AWS® automatically handles the execution, scaling, and infrastructure behind the scenes (e.g., by provisioning additional compute resources such as the processing devices 214 and the memory 218).

In some embodiments, the ALB 222 provides connectivity to the VPC 230 at various input locations. For example, the VPC 230 can include a host static website 232 (such as for AWS® S3 access), an API gateway 234 (which can be provided by AWS®), an identification and access management service 236 (such as AWS® Cognito) that provides access to services such as AWS® Simple Notification Service or AWS® SNS, and AWS® SES. Amazon® Cognito is a managed identity and access management service provided by AWS®, designed to handle user authentication, authorization, and user management for web and mobile apps. Thus, Cognito helps developers add secure login and user sign-up/sign-in features to applications, with support for third-party logins (like Google®, Facebook®, Apple®), as well as enterprise identity providers via security assertion markup language (SAML) or Open-D Connect (OIDC).

In embodiments, the identification and access management service 236 operates with a user sign-up (and sign-in) website page to enable secure creation of new user accounts (including validating an email address, password, and multi-factor authentication preference). The identification and access management service 236 can then also interact with the sign-in website page (which can be the same or different than the sign-up website page) to authenticate access by an authorized user that provides a valid email (or username) and password.

The VPC 230 can further include step functions 238 (which can be provided by AWS®), a serverless function service 240 (such as AWS® Lambda), and an object storage service 245 (such as AWS® S3). In embodiments, the serverless function service 240 obtains access to the object storage service 245, which in turn interfaces with the O-RAN lab 290 via the orchestration engine 248. Further, the serverless function service 240 can also obtain or provide access to the third party services 260, the relation database services 270, and the AWS® SES 280. In embodiments, Amazon® S3 is a cloud-based object storage service provided by AWS®. In embodiments, S3 is designed to store and retrieve any amount of data from anywhere on the internet with scalability, data availability, security, and performance. Customers of all sizes and industries store, manage, analyze, and protect any amount of data for virtually any use case, such as data lakes, cloud-native applications, and mobile apps. With cost-effective storage classes and easy-to-use management features, users can optimize costs, organize and analyze data, and configure fine-tuned access controls to meet specific business and compliance requirements.

In embodiments, AWS® step functions are a serverless orchestration service that enables coordinating multiple AWS® services into workflow sequences—called state machines—using a visual interface or JavaScript Objection Notation (JSON)-based definitions. Such AWS® step functions can enable managing multi-step, event-driven, or long-running processes, such as order processing, data pipelines, ML model training, and microservice coordination. Other step functions are envisioned.

The following Figures will illustrate deployment of the computing system 200, and associated O-RAN testing and validation portal architecture. This portal architecture can enable vendors (or other users) that are account managers to add new projects for different O-RAN components, see progress of testing those O-RAN components by the O-RAN lab 290, get detailed reports or project details (including progress through the phases of testing), update a user profile of the manager, manage the organization represented by the manager, add a new organization, and manage users, among other operations.

For each phase, the portal computing platform 220 triggers the O-RAN lab 290 to initiate a series of tests. The specific tests can vary by 5G O-RAN component type and phase. Systems of the O-RAN lab 290 can automate execution of test suites and collect the test results. In some embodiments, the O-RAN lab 290 employ multiple test lines, each capable of running a full test suite for a type of O-RAN component. Having multiple independent test lines allows for running multiple test projects in parallel.

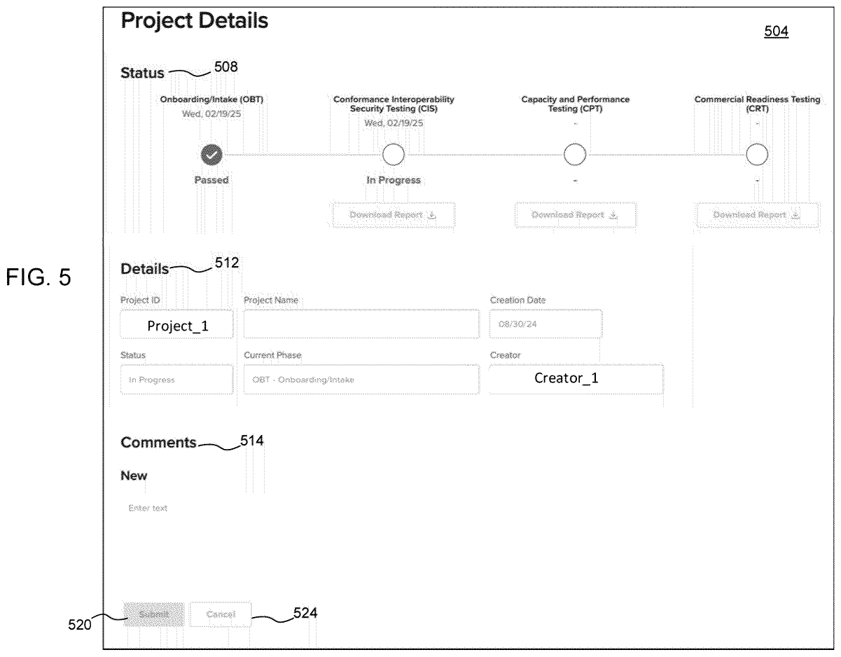

After the tests for a component type/phase are complete, the status can be automatically pushed from the O-RAN lab 290, through the orchestration engine 248, and pushed to a project results page for viewing by the requester, as will be illustrated in the following Figures. The portal computing platform 220 can also compile detailed test results into a document with pass/fail and reasons for failures for each individual test and make the test results document available for download on a project results page such as the project details page (e.g., the UI window 504 of FIG. 5). Each phase can have its own test results document and distinct set of tests in the document. Thus, in some embodiments, the orchestration engine 248 compiles, for each testing phase of the multiple testing phases, test results including a pass or fail status and creates a test results documents to include the test results. The orchestration engine 248 can then deliver the test results document to the project details page for download.

When a phase completes successfully, the orchestration engine 248 can automatically push the project to the next test phase and triggers the systems of the O-RAN lab 290 to run the appropriate test cases. If any test cases for a phase fail, the test phase fails, the final test results document can be created and made available for download and the test project marked as “failed” and is complete. If all test cases in all phases are successful, the test project can be marked as “passed” and is complete. During testing, the portal computing platform 220 can enable bidirectional communication between those in the public network 202 and/or those in the corporate network 212 and lab personnel via a messaging function. This facilitates lab personnel asking questions of a user who submitted the test project if, for example, there are questions about the component being tested.

In various embodiments, the orchestration engine 248 is implemented using ServiceNow®, which can employ one or more of multiple application programming interfaces (APIs), connectors, or middleware to automate data exchange and trigger workflows between the testing phases. For example, integrating the orchestration engine 248 with the object storage service 245 and other components of the VPC 230 can be performed via attachment offloading (store large file attachments in S3 instead of ServiceNow®'s internal database), data archiving (move closed projects or logs from ServiceNow® to S3 for long-term storage), automated incident creation (trigger a ServiceNow® incident if a certain file is uploaded to S3, e.g., via AWS Lambda plus SNS/SQS), and workflow extension (use ServiceNow® workflows to initiate S3 actions, e.g., create bucket, upload file via AWS® APIs.)

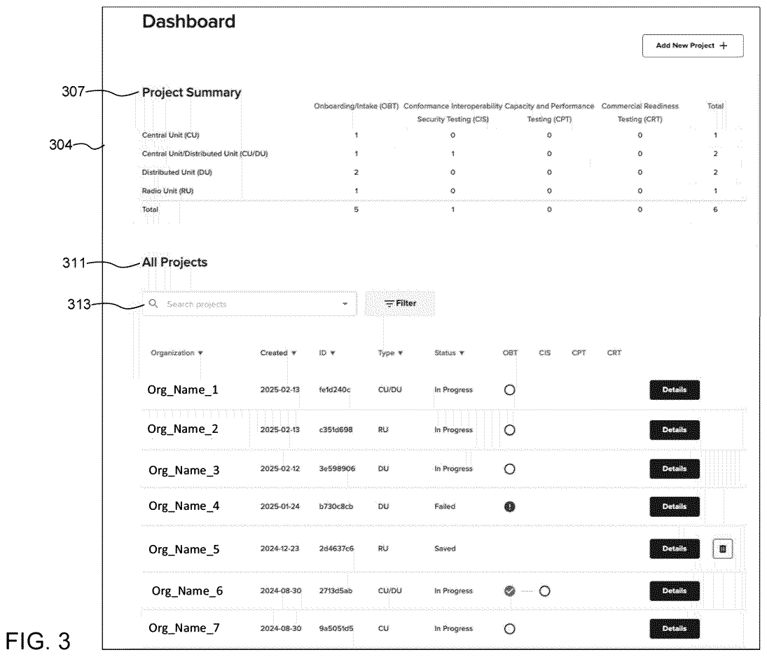

FIG. 3 is a user interface of the O-RAN portal illustrating a project summary and details dashboard page according to some embodiments. In some embodiments, the user interface is the UI 172 discussed with reference to FIG. 1B. The dashboard page may be displayed in a UI window 304 of the UI 172 and include a project summary 307 that lists how many projects are currently in flight, broken down by phase, e.g., in which phase these various projects (CUs, DUs, CU/DUs, RUs) are currently operating. The dashboard page can display projects across all organizations for internal users with “Admin,” “Project Approver,” “Testing,” “NTIA,” “Consortium Partner,” or “DISH Viewer” roles. As can be seen in the project summary 307, a first phase includes onboarding and intake (OBT), a second phase includes conformance interoperability security testing (CIS), a third phase includes capacity and performance testing (CPT), and a fourth (or final) phase includes commercial readiness testing (CRT). Each of these phases will be discussed in more detail with reference to FIG. 5.

The dashboard page may further include an all projects section 311 that lists all the projects in the O-RAN portal (e.g., being tracked on the portal computing platform 220 and being tested in the O-RAN lab 290). In some embodiments, the all projects section 311 includes a search field 313 through which a project can be searched according to certain, selectable criteria. Each project can include: 1) Organization Name; 2) when created; 3) project ID; 4) project type; 5) status; 6) current project phase; and 7) button/link to see “project details.” Each project may also include the user or manager ID of the person that opened the project. In this way, a snapshot of progress of all projects can be observed in the project summary 307 and the details associated with each project can be observed in the all projects section 311. Further, any given project can be found through browsing or searching.

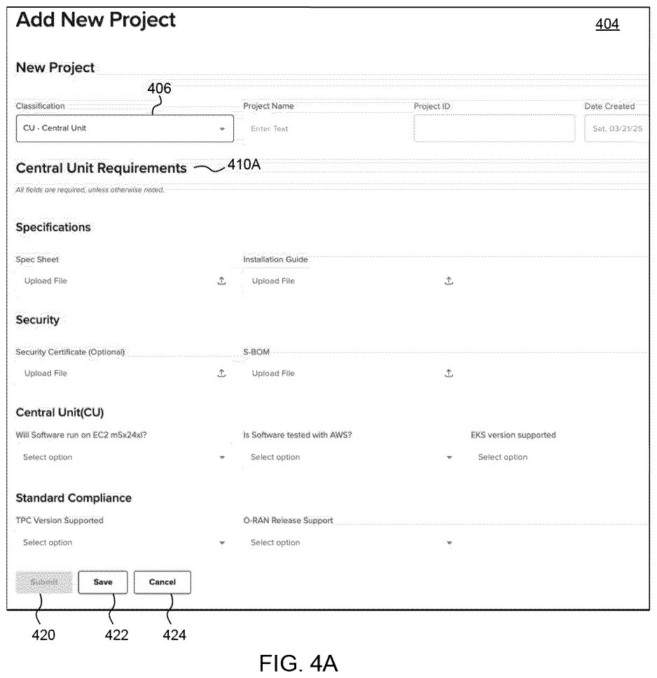

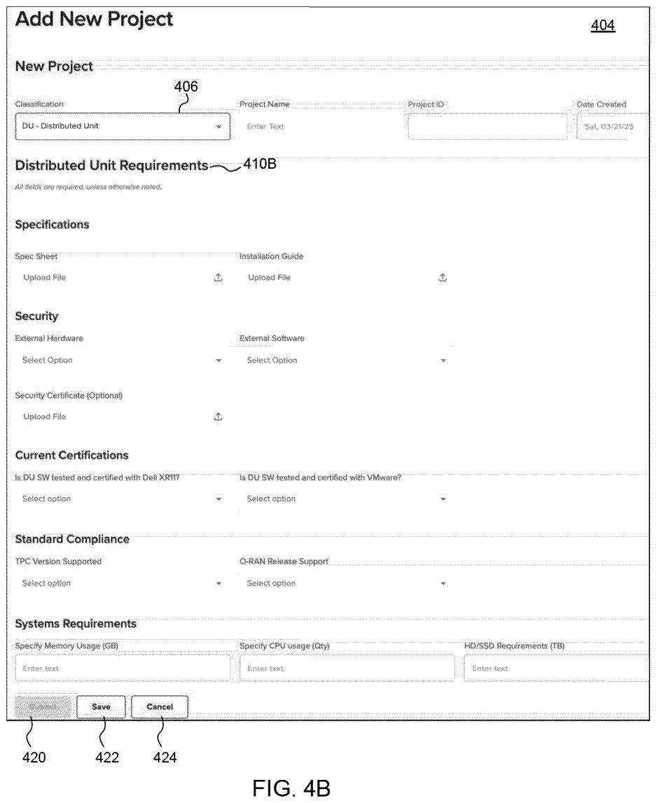

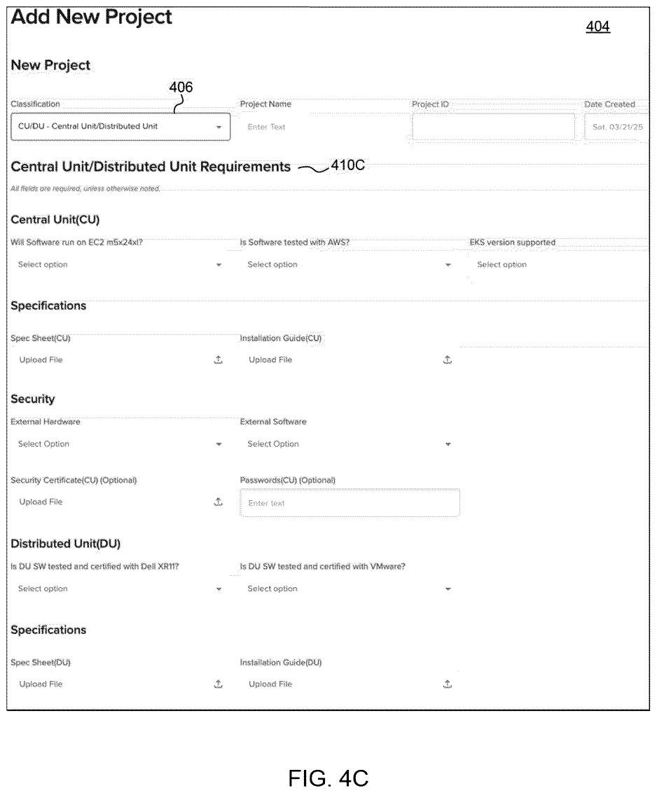

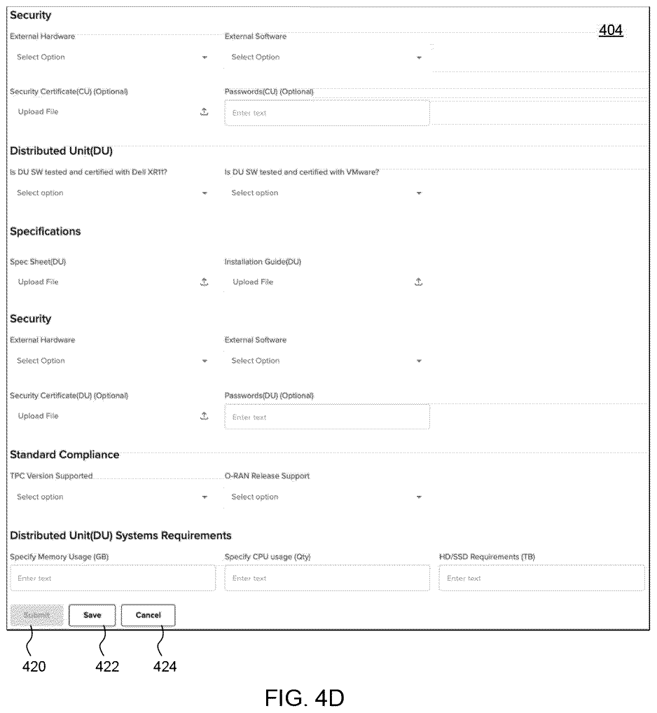

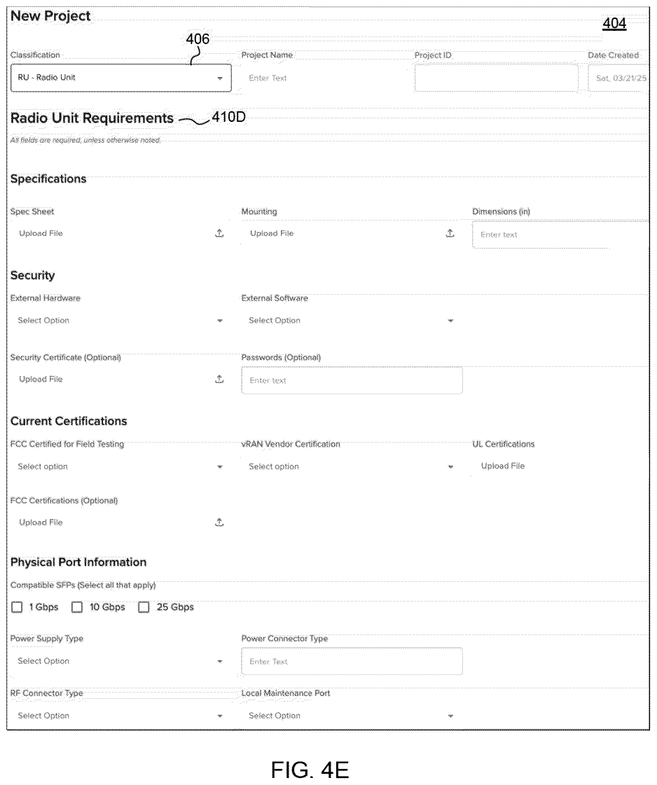

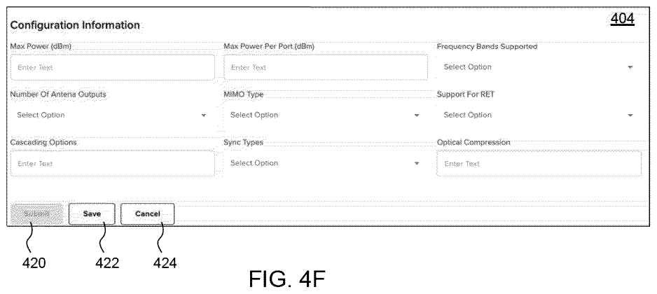

FIG. 4A is a user interface of the O-RAN portal illustrating an add new CU project page of a UI window 404 according to some embodiments. In such embodiments, an add new project page can be displayed in the window 404 within the UI 172. The UI window 404 can include a drop-down menu 406 for selecting a type of new project being added. Next to the drop-down menu 406 are fields (e.g., text upload fields) in which to enter the project name, project ID, and date created. Illustrated in FIG. 4A are fields and menus specific to adding a new CU project.

The UI window 404 can also include a CU requirements section 410A including file upload fields prompting a user to upload a specification sheet, an installation guide, a security certificate, a software bill of materials (S-BOM), and then several dropdown selection menus. The latter may include selections to choose from various testing parameters, including whether software will run on EC2 m5x24xI, whether software is to be tested with AWS®, and an Amazon® Elastic Kubernetes Service (EKS) version that is supported. The CU requirements section 410A can further include selection options for transmit power control (TPC) version supported and O-RAN release support (e.g., which release version of the 3GPP protocol is supported). The S-BOM may include a requirement that the file is in CycloneDX, SPDX, or common platform enumeration (CPE) formats.

In some embodiments, a submit button 420 is delivered to the UI window 404 through which the new project can be submitted to be added to the O-RAN portal. In embodiments, a save button 422 is delivered to the UI window 404 through which to save progress on adding the new CU project and a cancel button 424 is delivered to the UI window 404 through which to cancel adding the new CU project.

FIG. 4B is a user interface of the O-RAN portal illustrating an add new DU project page in the UI window 404 according to some embodiments. In such embodiments, an add new project page can be displayed in the UI window 404 of the UI 172. The UI window 404 can include a drop-down menu 406 for selecting a type of new project being added. Next to the drop-down menu 406 are fields (e.g., text upload fields) in which to enter the project name, project ID, and date created. Illustrated in FIG. 4B are fields and menus specific to adding a new DU project.

The UI window 404 can also include a DU requirements section 410B including file upload fields prompting a user to upload a specification sheet, an installation guide, external hardware, external software, and an optional security certificate (e.g., ISO 27001). The DU requirements section 410B can further include selection options to choose testing parameters such as whether the DU software is tested and certified with Dell XR11 and whether the DU software has been tested and certified with VMware. The DU requirements section 410B can further include selection options of whether for TPC version supported and O-RAN release support (e.g., which release version of the 3GPP protocol is supported). The DU requirements section 410B can further include input fields in which to submit system requirements information, such as memory usage, CPU usage, and hardware drive (HD) or solid-state drive (SSD) requirements.

In some embodiments, a submit button 420 is delivered to the UI window 404 through which the new project can be submitted to be added to the O-RAN portal. In embodiments, a save button 422 is delivered to the UI window 404 through which to save progress on adding the new DU project and a cancel button 424 is delivered to the UI window 404 through which to cancel adding the new DU project.

FIG. 4C and FIG. 4D are a user interface of the O-RAN portal illustrating an add new CU-DU project page in the UI window 404 according to some embodiments. In such embodiments, an add new project page can be displayed in the UI window 404 of the UI 172. The UI window 404 can include a drop-down menu 406 for selecting a type of new project being added. Next to the drop-down menu 406 are fields (e.g., text upload fields) in which to enter the project name, project ID, and date created. Illustrated in FIG. 4C are fields and menus specific to adding a new CU-DU project. For example, if the same vendor is wanting to test both a CU and a DU that are expected to inter-operate within the cellular network 120, the vendor organization can create a new project to test both the CU and the DU at the same, e.g., phased the same.

The UI window 404 can also include a CU/DU requirements section 410C including file upload fields prompting a user to upload particular documents or information, select from certain options (e.g., from a dropdown menu), or insert particular data or information. In various embodiments, the CU/DU requirements section 410C is a combination of the CU requirements section 410A (FIG. 4A) and the DU requirements section 410B (FIG. 4B).

In some embodiments, a submit button 420 is delivered to the UI window 404 through which the new project can be submitted to be added to the O-RAN portal. In embodiments, a save button 422 is delivered to the UI window 404 through which to save progress on adding the new CU-DU project and a cancel button 424 is delivered to the UI window 404 through which to cancel adding the new CU-DU project.

FIG. 4E and FIG. 4F are a user interface of the O-RAN portal illustrating an add new RU project page of the UI window 404 according to some embodiments. In such embodiments, an add new project page can be displayed in the UI window 404 of the UI 172. The UI window 404 can include a drop-down menu 406 for selecting a type of new project being added. Next to the drop-down menu 406 are fields in which to enter the project name, project ID, and date created. Illustrated in FIG. 4E are fields and menus specific to adding a new RU project.

The UI window 404 can also include a RU requirements section 410D including file upload fields prompting a user to upload a specification sheet, a type of mounting, and dimensions of the RU. The fields may also provide a means by which the user can select external hardware, external software, an optional security certificate (e.g., ISO 27001), and an optional password. The RU requirements section 410D can further include selection options to choose a type of Federal Communications Commission (FCC) certification for field testing, a vRAN vendor certification, UL certifications, or an optional FCC certification. The RU requirements section 410D can further include selection options for choosing compatible small form-factor pluggable (SFP) modules being tested, a power supply type, a power connector type, an RF connector type, and a local maintenance port.

The RU requirements section 410D can further include data entry fields through a user can enter configuration information such as maximum power, maximum power per port, frequency bands supported, a number of antenna outputs, a multiple input, multiple output (MIMO) type, a support for RET, cascading options, synchronization (synch) types, and optical compression.

In some embodiments, a submit button 420 is delivered to the UI window 404 through which the new project can be submitted to be added to the O-RAN portal. In embodiments, a save button 422 is delivered to the UI window 404 through which to save progress on adding the new RU project and a cancel button 424 is delivered to the UI window 404 through which to cancel adding the new RU project.

FIG. 5 is a user interface of the O-RAN portal illustrating a project details page in a UI window 504 that includes phase-based testing progress according to some embodiments. In at least one embodiment, the project details page of FIG. 5 is delivered to the UI window 504 (e.g., of the UI 172) in response to selection of a “details” button next to a project listed in the all projects section 311 of FIG. 3. In such embodiments, the project details page includes a status section 508, a details section 512, and a comments section 514.

In some embodiments, the status section 508 includes the various phases of testing, each phase being associated with a date when that phase completed, the phase that is still in progress, and greyed out illustrations of phases that have not yet begun. The various phases of testing can include, for example, a first phase, which includes onboarding and intake (OBT), a second phase, which includes conformance interoperability security testing (CIS), a third phase, which includes capacity and performance testing (CPT), and a fourth (or final) phase, which includes commercial readiness testing (CRT). The OBT phase can include review of information and data received in association with a new testing project of an O-RAN component to make sure the information and data is complete, the project is compliant with O-RAN standards (e.g., 3GPP and O-RAN protocols) and thus the new testing project can begin testing at the CIS phase.

The CIS phase can include testing the O-RAN component with other O-RAN components of different vendors in a commercially utilized component stack to ensure proper, and secure, interoperability with these other O-RAN components. The CPT phase can include testing the O-RAN component for running at a target capacity or performance (e.g., being able to handle a particular bandwidth, number of packets per minute, or other performance metric such as QoS).

The CRT phase (or final phase of testing) can include testing the O-RAN component in the field with live tower for commercial readiness in the sense that the O-RAN is fully capable of operating in a live production (commercial) network environment, e.g., within the cellular network 120. In various embodiments, commercial readiness means that the O-RAN component has successfully passed all necessary tests to confirm that the O-RAN component is stable and reliable under production-level traffic and conditions, interoperates correctly with other network elements (especially in a multi-vendor O-RAN environment), meets required performance, latency, throughput, and availability benchmarks, adheres to security, compliance, and regulatory requirements, and has validated field deployment procedures, including software updates and fault recovery.

Further, a report can be downloaded for each completed phase after OBT, e.g., via a report download button illustrated below, above, or adjacent to the respective phase. In some embodiments, a radial button is illustrated next to each phase label and that includes a colored icon corresponding to status. In embodiments, the colored icon of the radial button can be green (with an optional check in the middle) for “passed,” red (with an optional X in the middle) for “failed,” blue (or some other color besides green or red) for “in progress,” and white or transparent for “not yet started.” Thus, the information in the status section 508 provides a snapshot of the current progress of a particular testing project.

In some embodiments, the details section 512 includes the project ID, the project name, a creation date, a status of the project, a current phase of the project, and the creator of the project. In embodiments, the comments section 514 includes a text field into which comments can be left by the creator, manager, or other authorized user to provide context for the status and progress (or lack thereof) of the testing project. In some embodiments, a submit button 520 is delivered to the UI window 504 through which a new comment can be submitted to be added to the O-RAN portal in connection with the testing project. A cancel button 524 may also be delivered to the UI window 504 by which to cancel submission of the comment.

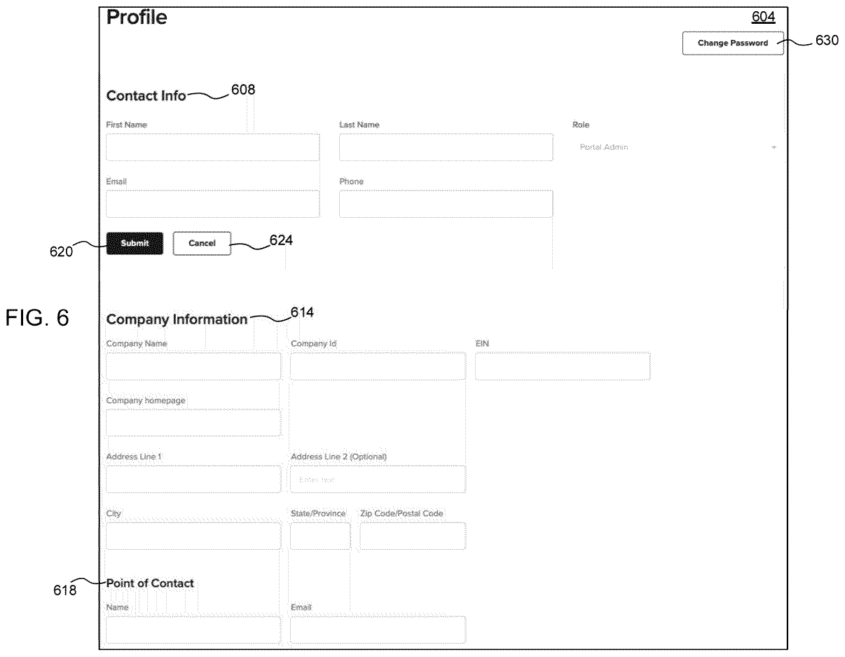

FIG. 6 is a user interface of the O-RAN portal illustrating a profile page in a UI window 604 according to some embodiments. In such embodiments, the UI window 604 can be delivered in the UI 172 illustrated and discussed with reference to FIG. 1B. The profile page may be accessed by clicking a profile link from a home page or account page (not illustrated). In embodiments, the profile page includes a contact information section 608, a company information section 614, and a point of contact section 618. The contact information section 608 can include data or text upload fields through which to supply personal contract information of a user that includes also designating the role of that user. The company information section 608 can include data or text upload fields through which to supply company-specific information, including company name, company ID, employment identification number (e.g., EIN or other tax number), and a company homepage. The point of contact section 618 can include data or text upload fields through which to submit and name and contact information for a point of contact associated with the company.

The profile page delivered to the UI window 604 can also include one or more submit buttons 620 to submit the information referenced above and a cancel button 624 through which to cancel submitting or changing profile information. The profile page can also include a change password button 630 through which a user can change password for logging into the UI 172 of the O-RAN portal.

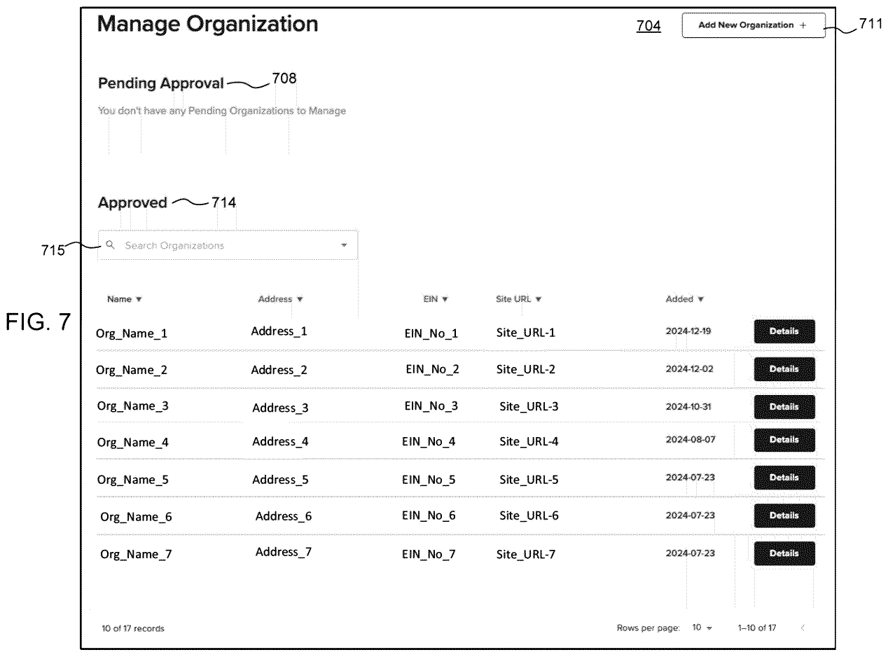

FIG. 7 is a user interface of the O-RAN portal illustrating a manage organization page in a UI window 704 according to some embodiments. In such embodiments, the UI window 704 can be delivered in the UI 172 illustrated and discussed with reference to FIG. 1B. The manage organization page may be accessed by clicking a manage organization link from a home page or account page (not illustrated). In some embodiments, the manage organization page within the UI window 704 includes an add-a-new-organization button 711, a pending approval section 708, and an approved section 714. The add-a-new-organization button 711 can be selected to add a new organization, which can include filling out the profile page discussed with reference to FIG. 6. The pending approval section 708 can list the organization still pending approval within the O-RAN portal (where none are listed at present). The approved section 714 can list approved organizations and their relevant information, such as organization name, address, EIN, site URL, when added, and a “details button” selectable to go to a screen (similar to the UI window 604) that includes these and additional organization details.

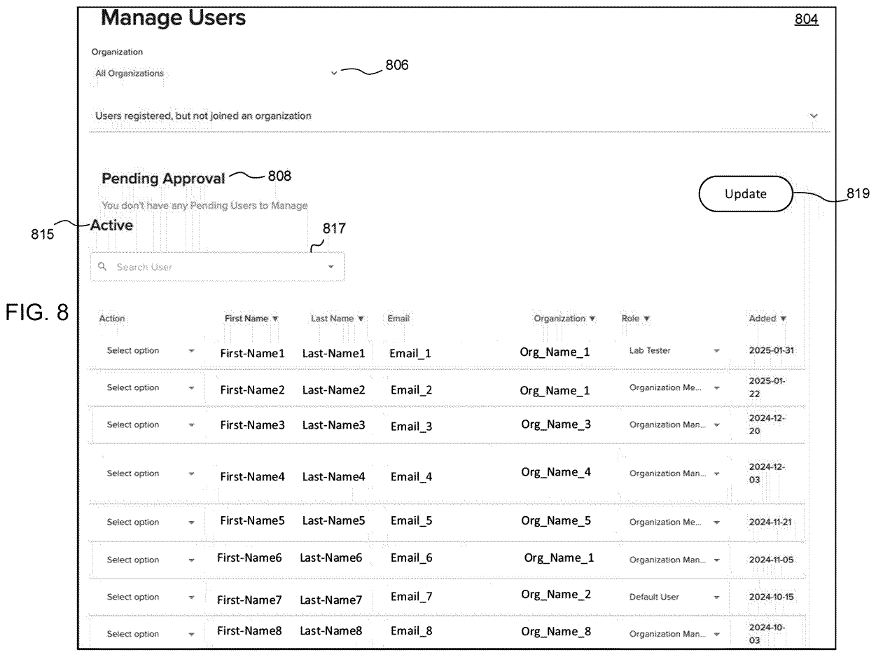

FIG. 8 is a user interface of the O-RAN portal illustrating a manage users page in a UI window 804 according to some embodiments. In such embodiments, the UI window 804 can be delivered in the UI 172 illustrated and discussed with reference to FIG. 1B. The manage users page may be accessed by clicking a manage users link from a home page or account page (not illustrated). In some embodiments, the manage users page within the UI window 704 includes an organization selection dropdown menu 806 to select all organizations or just a subset of organizations (depending on how many results a manager wishes to review). The manage users page can also include a pending approval section 808 in which users that have been entered but not yet approved would be listed (although none are actually illustrated in FIG. 8). The manage users page can also include an active user section 815 in which is listed the active users for the selected organization. A users search bar 817 can be delivered to the UI window 804 to facilitate searching for a particular active user.

In some embodiments, each listed active user in the active user section 815 can include a first name, a last name, an email address, an organization name, a role of the user, and a date the user was added into the O-RAN portal. The users listed in the pending approval section 808 can also include this information, except not yet having the added date. Each listed user can also include a “selection option” dropdown menu to enable actions be performed such as removing the user or requesting to update user information. An update button 819 can also be delivered to the UI window 804 that, when selected, performs all the selected options across one or more of the listed users in the active user section 815.

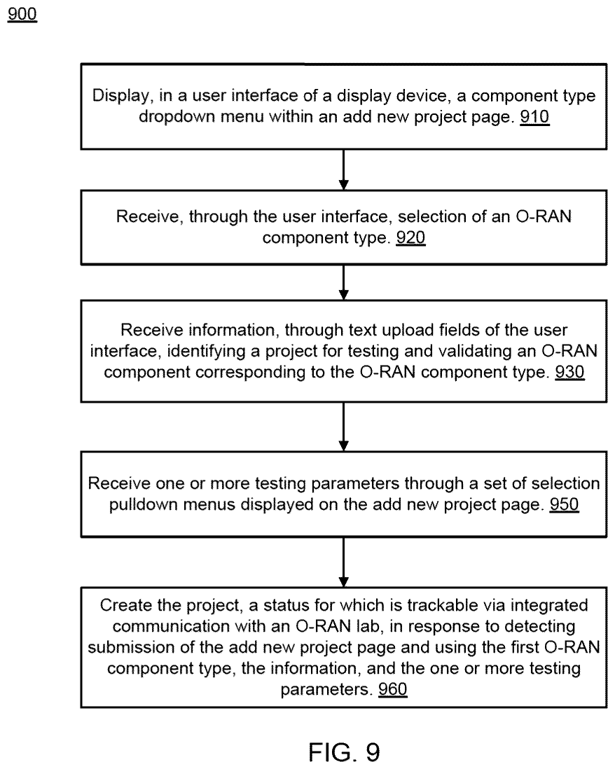

FIG. 9 is a flow chart of an example method 900 for creating a new project for performing O-RAN component testing and validation according to some embodiments. The method 900 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 900 is performed by the computing system 150 of FIGS. 1A-1B or the computing system 200 of FIG. 2. For example, the processing logic can include the one or more processing devices 214 configured to execute instructions stored in the memory 218 (e.g., non-transitory computer-readable storage medium having stored therein processor-readable instructions). The operations of the method 900 can be performed in an order other than that specifically illustrated, can include additional operations, or fewer operations than those illustrated in different embodiments.

At operation 910, the processing logic displays, in a user interface of a display device, a component type dropdown menu within an add new project page (see FIGS. 4A-4E).

At operation 920, the processing logic receives, through the user interface, selection of an O-RAN component type.

At operation 930, the processing logic receives information, through text upload fields of the user interface, identifying a project for testing and validating an O-RAN component corresponding to the O-RAN component type.

At operation 940, the processing logic receives one or more testing parameters through a set of selection pulldown menus displayed on the add new project page.

At operation 950, the processing logic creates the project, a status for which is trackable via integrated communication with an O-RAN lab, in response to detecting submission of the add new project page and using the O-RAN component type, the information, and the one or more testing parameters.

The processing logic can further receive, from file upload fields of the new project page, one or more of a specification sheet, an installation guide, or a security certificate. The processing logic can further use the one or more of the specification sheet, the installation guide, or the security certificate to create the project for execution by an O-RAN lab. The processing logic can store, in the memory 218, the project and corresponding data and information

The processing logic can further automate communication integration with an O-RAN lab based on the created project, receive project progress updates from the O-RAN lab comprising a status of testing across a plurality of testing phases, and update the project details page deliverable to the user interface, e.g., the UI window 504 of FIG. 5. The plurality of testing phases can include onboarding and intake, conformance interoperability and security, capacity and performance, and/or commercial readiness (see project details page of FIG. 5).

In at least some embodiments, the project details page includes in which testing phase, of plurality of testing phases, the project resides. For example, automating communication integration can include executing the orchestration engine 248 employing one or more of multiple application programming interfaces (APIs), connectors, or middleware to automate data exchange and trigger workflows between the plurality of testing phases.

The processing logic can further deliver a submission button to the user interface. The processing logic can further detect selection of the submission button to detect submission of the add new project page for processing to create the project.

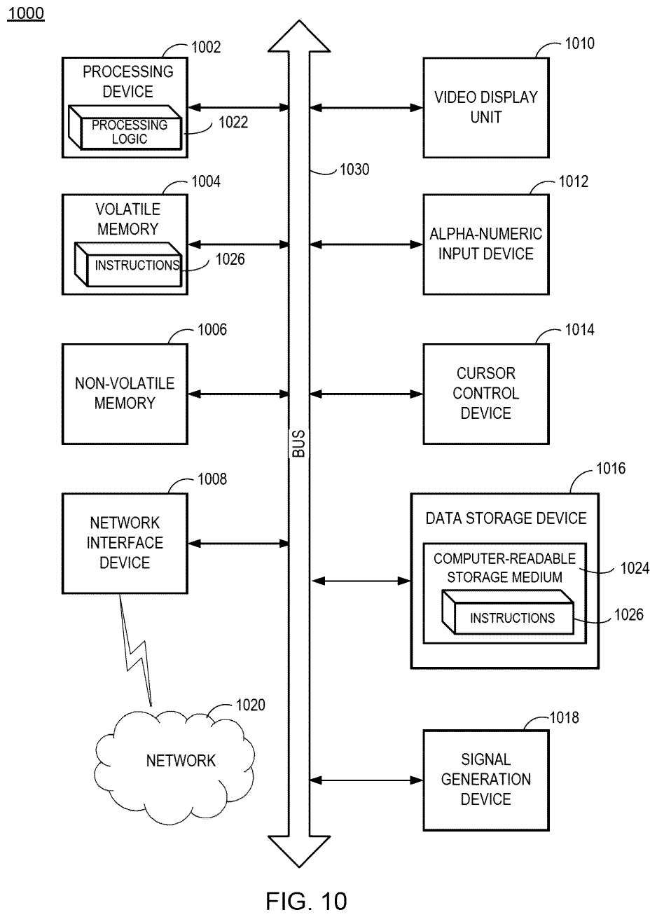

FIG. 10 illustrates a block diagram illustrating an exemplary computer device 1000 (or computing device), in accordance with implementations of the present disclosure. Computer device 1000 can correspond to the computing system 150 (or device) or the computing system 200, as described above. Example computer device 1000 can be connected to other computer devices in a LAN, an intranet, an extranet, and/or the Internet. Computer device 1000 can operate in the capacity of a server in a client-server network environment. Computer device 1000 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 1000 can include a processing device 1002 (also referred to as a processor, CPU, or GPU), a volatile memory 1004 (or main memory, e.g., read-only memory (ROM), flash memory, dynamic random access memory (DRAM) such as synchronous DRAM (SDRAM), etc.), a non-volatile memory 1006 (e.g., flash memory, static random access memory (SRAM), etc.), and a secondary memory (e.g., a data storage device 1016), which can communicate with each other via a bus 1030.

Processing device 1002 (which can include processing logic 1022) represents one or more general-purpose processing devices such as a microprocessor, central processing unit, or the like. More particularly, processing device 1002 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1002 can also be one or more special-purpose processing devices such as an ASIC, a FPGA, a digital signal processor (DSP), network processor, or the like. In accordance with one or more aspects of the present disclosure, processing device 1002 can be configured to execute instructions performing the method disclosed herein.

Example computer device 1000 can further comprise a network interface device 1008, which can be communicatively coupled to a network 1020. Example computer device 1000 can further comprise a video display 1010 (e.g., a LCD (liquid crystal display) or organic light-emitting diode (OLED) monitor, a virtual-reality (VR) or augmented-reality (AR) display, a touch screen, or a cathode ray tube (CRT)), an alphanumeric input device 1012 (e.g., a keyboard), a cursor control device 1014 (e.g., a mouse, track ball, or touch pad), and an acoustic signal generation device 1018 (e.g., a speaker). Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Data storage device 1016 can include a computer-readable storage medium 1024 (or, more specifically, a non-transitory computer-readable storage medium) on which is stored one or more sets of executable instructions 1026 (e.g., processor-readable instructions). In accordance with one or more aspects of the present disclosure, executable instructions 1026 can comprise executable instructions performing the method disclosed herein.

Executable instructions 1026 (or processor-readable instructions) can also reside, completely or at least partially, within volatile memory 1004 and/or within processing device 1002 during execution thereof by example computer device 1000, volatile memory 1004 and processing device 1002 also constituting computer-readable storage media. Executable instructions 1026 can further be transmitted or received over a network via network interface device 1008.

While the computer-readable storage medium 1024 is shown in FIG. 10 as a single medium, the term “computer-readable storage medium” or “non-transitory computer-readable storage medium storing instructions” or “computer-readable instructions” should be taken to include a single medium or multiple media (e.g., a central or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A computing system executing an open radio access network (O-RAN) testing and validation portal architecture, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
displaying, in a user interface of a display device, a component type dropdown menu within an add new project page;
receiving, through the user interface, selection of an O-RAN component type;
receiving information, through text upload fields of the user interface, identifying a project for testing and validating an O-RAN component corresponding to the O-RAN component type;
receiving one or more testing parameters through a set of selection pulldown menus displayed on the add new project page; and
creating the project, a status for which is trackable via integrated communication with an O-RAN lab, in response to detecting submission of the add new project page and using the O-RAN component type, the information, and the one or more testing parameters.

2. The computing system of claim 1, wherein the operations further comprise:
receiving, from file upload fields of the new project page, one or more of a specification sheet, an installation guide, or a security certificate;
using the one or more of the specification sheet, the installation guide, or the security certificate to create the project for execution by the O-RAN lab; and
storing, in the memory, the project and corresponding data and information.

3. The computing system of claim 1, wherein the operations further comprise:
automating communication integration with the O-RAN lab based on the created project;
receiving project progress updates from the O-RAN lab comprising a status of testing across a plurality of testing phases; and
updating a project details page that is deliverable to the user interface, wherein the project details page includes in which testing phase, of plurality of testing phases, the project resides.

4. The computing system of claim 3, wherein automating communication integration comprises executing an orchestration engine employing one or more of a plurality of application programming interfaces (APIs), connectors, or middleware to automate data exchange and trigger workflows between the plurality of testing phases.

5. The computing system of claim 3, wherein the plurality of testing phases comprise one or more of onboarding and intake, conformance interoperability and security, capacity and performance, or commercial readiness.

6. The computing system of claim 3, wherein the operations further comprise:
compiling, for each testing phase of the plurality of testing phases, test results including a pass or fail status;
creating a test results document to include the test results; and
delivering the test results document to the project details page for download.

7. The computing system of claim 1, wherein the operations further comprise:
delivering a submission button to the user interface; and
detecting selection of the submission button to detect submission of the add new project page for processing to create the project.

8. The computing system of claim 1, wherein the O-RAN component type comprises one of a central unit (CU), a distributed unit (DU), a combination of a CU and a DU, or a radio unit (RU).

9. A method of operating a computing system to perform open radio access network (O-RAN) testing and validation, comprising:
displaying, in a user interface of a display device of the computing system, a component type dropdown menu within an add new project page;
receiving, through the user interface, selection of an O-RAN component type;
receiving information, through text upload fields of the user interface, identifying a project for testing and validating an O-RAN component corresponding to the O-RAN component type;
receiving one or more testing parameters through a set of selection pulldown menus displayed on the add new project page; and
creating the project, by one or more processing devices of the computing system, a status for which is trackable via integrated communication with an O-RAN lab, in response to detecting submission of the add new project page and using the O-RAN component type, the information, and the one or more testing parameters.

10. The method of claim 9, further comprising:
receiving, from file upload fields of the new project page, one or more of a specification sheet, an installation guide, or a security certificate;
using the one or more of the specification sheet, the installation guide, or the security certificate to create the project for execution by the O-RAN lab; and
storing, in memory of the computing system, the project and corresponding data and information.

11. The method of claim 9, further comprising:
automating communication integration with the O-RAN lab based on the created project;
receiving project progress updates from the O-RAN lab comprising a status of testing across a plurality of testing phases; and
updating a project details page that is deliverable to the user interface, wherein the project details page includes in which testing phase, of the plurality of testing phases, the project resides.

12. The method of claim 11, wherein
automating communication integration comprises executing an orchestration engine employing one or more of a plurality of application programming interfaces (APIs), connectors, or middleware to automate data exchange and trigger workflows between the plurality of testing phases; and
the plurality of testing phases comprise one or more of onboarding and intake, conformance interoperability and security, capacity and performance, or commercial readiness.

13. The method of claim 11, further comprising:
compiling, for each testing phase of the plurality of testing phases, test results including a pass or fail status;
creating a test results document to include the test results; and
delivering the test results document to the project details page for download.

14. The method of claim 9, further comprising:
delivering a submission button to the user interface; and
detecting selection of the submission button to detect submission of the add new project page for processing to create the project.

15. A non-transitory computer-readable storage medium storing instructions, which when executed by one or more processing devices of a computing system executing an O-RAN testing and validation portal architecture, cause the one or more processing devices to perform operation comprising:
displaying, in a user interface of a display device of the computing system, a component type dropdown menu within an add new project page;
receiving, through the user interface, selection of an O-RAN component type;
receiving information, through text upload fields of the user interface, identifying a project for testing and validating an O-RAN component corresponding to the O-RAN component type;
receiving one or more testing parameters through a set of selection pulldown menus displayed on the add new project page; and
creating the project, a status for which is trackable via integrated communication with an O-RAN lab, in response to detecting submission of the add new project page and using the O-RAN component type, the information, and the one or more testing parameters.

16. The non-transitory computer-readable storage medium of claim 15, wherein the operations further comprise:
receiving, from file upload fields of the new project page, one or more of a specification sheet, an installation guide, or a security certificate;
using the one or more of the specification sheet, the installation guide, or the security certificate to create the project for execution by the O-RAN lab; and
storing, in a memory of the computing system, the project and corresponding data and information.

17. The non-transitory computer-readable storage medium of claim 15, wherein the operations further comprise:
automating communication integration with the O-RAN lab based on the created project;
receiving project progress updates from the O-RAN lab comprising a status of testing across a plurality of testing phases; and
updating a project details page that is deliverable to the user interface, wherein the project details page includes in which testing phase, of plurality of testing phases, the project resides.

18. The non-transitory computer-readable storage medium of claim 17, wherein
automating communication integration comprises executing an orchestration engine employing one or more of a plurality of application programming interfaces (APIs), connectors, or middleware to automate data exchange and trigger workflows between the plurality of testing phases; and
the plurality of testing phases comprise one or more of onboarding and intake, conformance interoperability and security, capacity and performance, or commercial readiness.

19. The non-transitory computer-readable storage medium of claim 17, wherein the operation further comprise:
compiling, for each testing phase of the plurality of testing phases, test results including a pass or fail status;
creating a test results documents to include the test results; and
delivering the test results document to the project details page for download.

20. The non-transitory computer-readable storage medium of claim 15, wherein the operations further comprise:
delivering a submission button to the user interface; and
detecting selection of the submission button to detect submission of the add new project page for processing to create the project.
